(19) United States
(12) Patent Application Publication
(10) Pub. No.: US 2022/0245526 A1
(43) Pub. Date: Aug. 4, 2022

(54) QUANTILE HURDLE MODELING SYSTEMS AND METHODS FOR SPARSE TIME SERIES PREDICTION APPLICATIONS

(71) Applicant: Intuit Inc., Mountain View, CA (US)

(72) Inventors: Apoorva Banubakode, Mountain View, CA (US); Sambarta Dasgupta, Mountain View, CA (US)

(73) Assignee: Intuit Inc., Mountain View, CA (US)

(21) Appl. No.: 17/163,018

(22) Filed: Jan. 29, 2021

(51) Int. Cl. G06N 20/20; G06N 7/00; G06K 9/62; G06F 16/904

(52) U.S. Cl. CPC G06N 20/20; G06N 7/005; G06F 16/904; G06K 9/6249; G06K 9/6244

(57) ABSTRACT

A server computer may receive and process a plurality of time series data to generate sparse datasets based on sparsity levels. The server computer applies a time series forecasting model to each respective subset of previous data points of the sparse datasets increasingly at the first time granularity to generate a set of prediction values and a set of residuals; applies a regression model to the set of the prediction residuals to generate a set of adjusted residuals for the sparse datasets; and generates a visualized explanation based on the set of the prediction values and the set of adjusted residuals for one or more of the sparse datasets.

### BACKGROUND

Time series data represents historic sequenced data over a range of time. Time series data may capture trends and patterns relating to events in different technology fields such as cloud usage, natural phenomenon prediction, service management, user activities, sales analysis, transaction management, etc. Predicting or forecasting time series may be performed by providing historical time series data to a predictive modeling system. The predictive modeling system can forecast those time series data into the future and generate time-series prediction results. The prediction results provide insights into activities or events that may occur in the future. The forecast results may provide valuable information to guide related users and entities to plan their future activities. There are technical challenges to forecast sparse time series that arise when making predictions based on events that occurred sporadically, as these events may not have repetitive patterns.

### BRIEF DESCRIPTION OF THE FIGURES

The foregoing and other aspects of embodiments are described in further detail with reference to the accompanying drawings, in which the same elements in different figures are referred to by common reference numerals. The embodiments are illustrated by way of example and should not be construed to limit the present disclosure.

FIG. 1 illustrates an example computing system for generating time series prediction in accordance with some embodiments disclosed herein.

FIGS. 2A-2C are schematic diagrams of an example time series prediction system in accordance with some embodiments disclosed herein.

FIG. 3 illustrates an example process for generating time series datasets in accordance with some embodiments disclosed herein.

FIG. 4 is a flowchart illustrating an example process of performing time series prediction with a Hurdle Regressor for moderately sparse time series datasets in accordance with some embodiments disclosed herein.

FIG. 5 show example plots generated based on outputs of a time series prediction model for processing moderately sparse time series datasets in accordance with some embodiments disclosed herein.

FIG. 6 shows scaled residuals corresponding to prediction intervals for moderately sparse time series datasets in accordance with some embodiments disclosed herein.

FIG. 7 shows example plots generated based on outputs of the Quantile regressor for processing moderately sparse time series datasets in accordance with some embodiments disclosed herein.

FIG. 8 is a flowchart illustrating an example process for processing extremely sparse time series datasets to build an explainable quantile Hurdle modeling system to forecast using extremely sparse time series in accordance with some embodiments disclosed herein.

FIG. 9 shows example plots generated based on outputs of a time series prediction model for processing extremely sparse time series datasets in accordance with some embodiments disclosed herein.

FIG. 10 shows example plots generated based on outputs of a quantile regressor for processing extremely sparse time series datasets in accordance with some embodiments disclosed herein.

FIG. 11 shows an example interface presenting prediction explanations of the forecast result in accordance with some embodiments disclosed herein.

FIG. 12 is a block diagram of an example computing device in accordance with some embodiments disclosed herein.

### DETAILED DESCRIPTION

Embodiments of the present disclosure provide forecasting techniques for accurately predicting sparse time series data relating to events in various technology fields.

Time series data may be categorized into different groups such as moderately sparse time series data and extremely sparse time series data based on sparsity levels representing extent of changes occurring in time series data over a range of time. The existing time series prediction models may predict sparse time series data with accurate mean/median values. However, there is a need to provide a modeling system to provide a prediction accuracy regarding prediction intervals and confidence bounds for the sparse time series data.

The existing time series prediction models may predict correct mean values for sparse time series data. However, the existing time series prediction models may generate a wide range of prediction intervals with a wide upper confidence bound and a wider upper confidence on both sides of the predicted mean values, which are caused by assuming Gaussian noise in the sparse time series data during the time series prediction process. The resulting prediction results, with a wide range of prediction intervals and wide confidence bounds, may lead to uncertain estimates of the prediction intervals and may not provide very useful prediction information for sparse time series data, thereby failing to predict related events that occur in the future. Further, the outputs of the existing time series prediction modes do not show that the sparse time series have Gaussian distribution features due to the non-Gaussian distribution of the prediction residuals associated with the prediction values and prediction intervals generated by the existing time series prediction models.

The present invention may provide a practical solution to problems described above with quantile hurdle modeling systems to generate accurate and useful prediction information for sparse time series data.

In one or more embodiments, a quantile hurdle modeling system may include a time series prediction model and a quantile regression model to perform prediction for moderate sparse time series data. The time series prediction model may generate the prediction values and prediction intervals for moderate sparse time series data. The quantile regression model may perform auto-regression to estimate different quantiles of the prediction residuals to generate adjusted prediction residuals with much tight prediction intervals and confidence bounds which are more relevant to time series data. A sparse time series prediction system may utilize the adjusted prediction residuals and the prediction values to generate accurate prediction explanation to be presented to users associated with the sparse time series data.

In one or more embodiments, for extremely sparse time series data, a quantile hurdle modeling system may include a Hurdle classifier, a time series prediction model and a quantile regression model considering period probabilities associated with extremely sparse time series data to generate accurate prediction result and improve prediction accuracy. The time series prediction model may generate the prediction values and prediction intervals for extremely sparse time series data. The quantile regression model may perform auto-regression to estimate different quantiles of the prediction residuals to generate adjusted prediction residuals with tight prediction intervals and confidence bounds which are more relevant to time series data. A Hurdle classifier may generate period probabilities of each sub-period extremely sparse time series data. A quantile hurdle modeling system may evaluate the generated prediction values and adjusted prediction residuals with the period probabilities of each sub-period of extremely sparse time series data to generate accurate prediction explanations and improve prediction accuracy.

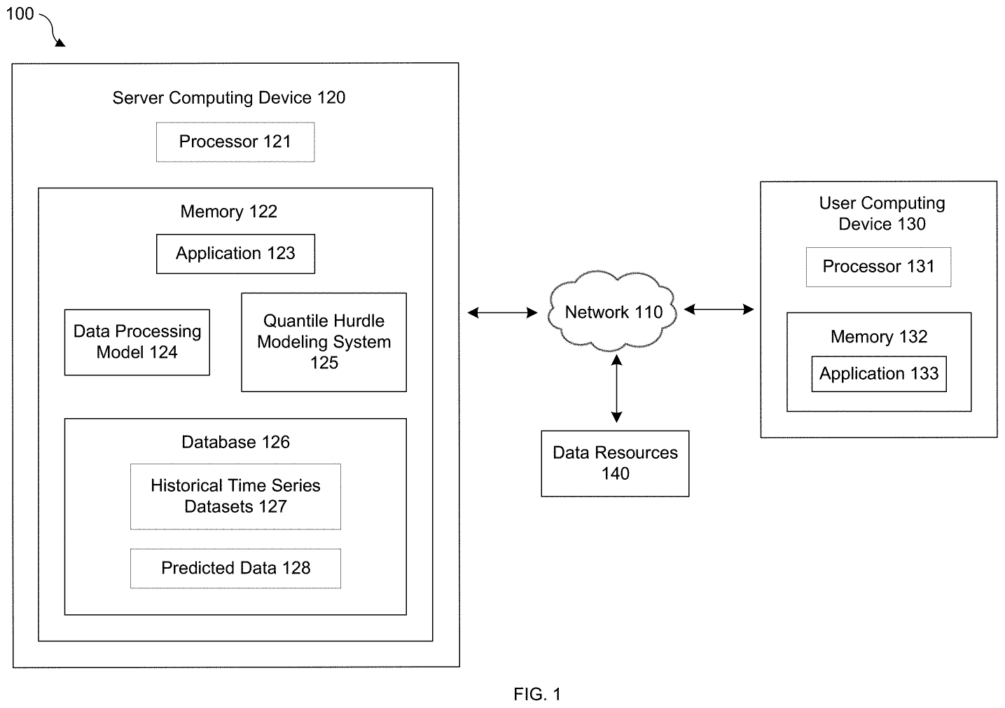

FIG. 1 illustrates an example computing system 100 for generating time series prediction in accordance with some embodiments disclosed herein. The example computing system 100 includes a server computing device or a server computer 120 and a plurality of user computing devices 130 that may be communicatively connected to one another in a cloud-based or hosted environment by a network 110. Server computer 120 may include a processor 121, memory 122 and communication interface for enabling communication over network 110. Server computer 120 hosts one or more online software financial services or software products, which may be examples of one or more applications 123 stored in memory 122. The one or more applications 123 (e.g., online services and or applications) are executed by processor 121 for providing various online services or providing one or more websites with services for users to manage their online activities/events related to time series data changes within a time range. For example, the one or more applications 123 may continuously receive and update time series data from various services or institutions via the network 110. Memory 122 may store a sparse time series prediction system or application including data processing model 124, Quantile Hurdle modeling system 125 and other program models, which are implemented in the context of computer-executable instructions executed by the processor 121 of server computer 120 for implementing methods, processes, systems and embodiments described in the present disclosure. Generally, computer-executable instructions include software programs, objects, models, components, data structures, and the like that perform functions or implement specific data types. The computer-executable instructions may be stored in a memory 122 communicatively coupled to a processor 121 and executed by the processor 121 to perform one or more methods described herein. Network 110 may include the Internet and/or other public or private networks or combinations thereof.

A user computing device 130 may include a processor 131, memory 132, and an application browser 133. For example, a user device 130 may be a smartphone, personal computer, tablet, laptop computer, mobile device, or other device. Users may be registered customers or entities of the one or more online applications 123. Each user may create a user account with user information for subscribing and accessing an online software product or service provided by server computer 120. Each user account is stored as a user dataset associated with time series data or datasets described below.

Database 126 of the example system 100 may be included in server computer 120, or coupled to and in communication with the processor 121 of the server computer 120 via the network 110. Database 126 may be a shared remote database, a cloud database, or an on-site central database. Database 126 may receive instructions or data from, and send data to, server computer 120. In some embodiments, server computer 120 may retrieve and aggregate a large amount of time series data such as stream data, transaction data, text, image, video, etc., by accessing other servers or databases from various data sources 140 via network 110. Database 126 may store the aggregated time series data at a daily granularity, a weekly granularity, etc. The historical time series may be represented by time series datasets within a time span in a corresponding time step. Database 126 may store and update historical time series datasets 127 associated with events and corresponding users/entities via the network 110. Database 126 may store the time series datasets for building a Quantile hurdle modeling system 125 to forecast extremely sparse time series to generate prediction or predicted data 128 associated with events that may occur in the future. Database 126 may store prediction results as predicted data 128 to generate textual and or graphical reports for associated entities. Details related to building the Quantile Hurdle modeling system 125 will be described below.

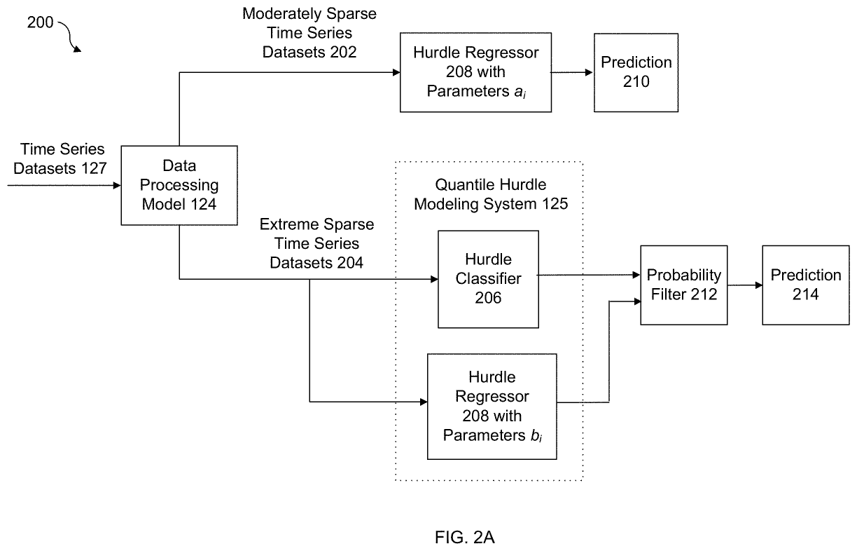

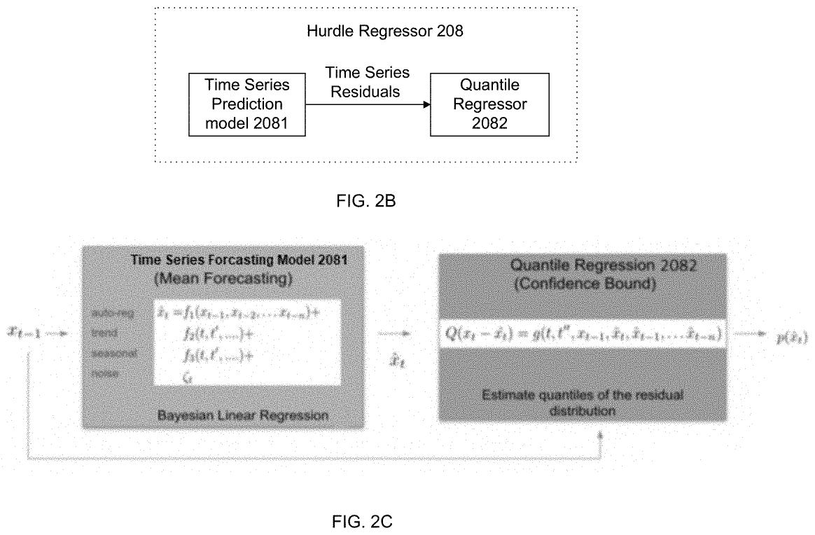

FIGS. 2A-2C are schematic diagrams of an example time series prediction system 200 in accordance with the disclosed principles. System 200 may be implemented as computer programs executed by the processor 121 of the server computer 120 for implementing various functionalities of models, modeling systems, algorithms, processes, and embodiments various processes and embodiments described herein. System 200 may explore modeling techniques (e.g., machine learning algorithms or models) compatible with sparsity levels of time series datasets and generate the predictions for the time series datasets. System 200 may include a data processing model 124 and an explainable Quantile Hurdle modeling system 125.

Time series data may represent event data that includes, but is not limited to, cloud usage (e.g., storage usage or cost analysis), digital signal processing, audio/video processing, natural phenomenon data (e.g., weather information), entity activities or behaviors, national economy, market forecasting, financial service management data (e.g., transactions, payment, or sales), and any other time step data, etc.

A process of feature engineering may be performed by the server computer 120 to apply to historical time series data to extract and construct historical time series datasets 127 associated with time series events. Each time series dataset may be associated with a time series identifier and include a set of data points indicating values at respective time steps. The time step granularity of time series values may be represented by temporal features depending on the granularity of the prediction.

In the absence of any data points between previous adjacent time steps, the time series may be imputed with zeros to satisfy a constant granularity gap amongst data points.

System 200 may include a data processing model 124 to process and group time serial datasets 127 into two groups of moderately sparse time series datasets 202 and extremely sparse time series datasets 204. An appropriate time series predicting model may be selected to be particularly suited to the type of time series, such as a sparsity level of time series datasets. The grouped time serial datasets 127 may be used as time series training data and time series test data to train the corresponding models and molding system.

A given time series may consist of systematic components including the average value in the series, trend indicative of the increasing or decreasing value in the series, seasonality indictive of the repeating short-term cycle in the series, and one non-systematic random variation or noise in the series. A given time series dataset may include a value and a set of temporal features. A set of temporal features may include date, day, week, month, working day, day of the week, week of the month, quarter, month start, etc.

For moderate sparse time series datasets, Hurdle Regressor 208 may be used to generate time series prediction. As illustrated in FIGS. 2A-2C, Hurdle regressor 208 may include a time series prediction model 2081 followed by a quantile regressor 2082 (e.g., quantile regression model) model 2082 to forecast target prediction values for the moderate sparse time series datasets 202. The time series prediction model 2081 may be a Bayesian linear regression model such as a Structural Bayesian Time Series (SBTS) model.

The time series prediction model 2081 may predict and generate a prediction value or a mean/median value \hat{x}ₜ at a time step is (e.g., weekly, or monthly, etc.) based on a subset of time series datasets or a subset of previous data points with actual values (xₜ₋ₙ, . . . xₜ₋₁) before the time step tₛ corresponding to previous events. The time series prediction model 2081 may further generate a prediction interval and prediction residual (xₜ-\hat{x}t) at the time step is based on the subset of time series datasets. A prediction interval may represent a range of likely prediction values of an output variable from the time series prediction model 2081 at the time step tₛ. A residual (xₜ-\hat{x}t) may be calculated and determined as a difference between the actual time series value xₜ and the prediction value \hat{x} at the time step tₛ.

Quantile regressor 2082 may be a quantile regression based machine learning model. As illustrated in FIGS. 2B-2C, Quantile regressor 2082 may perform quantile-based confidence bound computation based on the residuals (xₜ-\hat{x}ₜ) generated by the time series prediction model 2081 and a set of model parameters bᵢ. Quantile regressor 2082 may estimate the confidence bound to generate accurate prediction intervals.

Quantile regressor 2082 may be represented as an equation (1):

Q(xₜ-\hat{x}ₜ)=g(t, t″, xₜ₋₁, \hat{x}ₜ, \hat{x}ₜ₋₁. . . \hat{x}ₜ₋ₙ) (1)

Quantile regressor 2082 may be trained with prediction values \hat{x}ₜ, the residuals (xₜ-\hat{x}ₜ) from the time series prediction model 2081, and a set of parameters bᵢ to estimate the probability distribution of the residuals (xₜ-\hat{x}ₜ) around the mean/median value \hat{x}ₜ. In some embodiments, the set of model parameter bᵢ may be generated by fitting the residuals (xₜ-\hat{x}ₜ) into the quantile regressor model 2082. For example, the set of parameters bᵢ may comprise a set of quantile values and a plurality of temporal features (t, t″) including a date, day, week, month, day of the week, week of the month, etc. For example, Quantile regressor 2082 may be trained to estimate and predict the time series residuals at different quantiles such as 10%, 50%, 90%, etc. In some embodiments, the quantile regression may provide a non-parametric way of estimating probabilistic prediction by utilizing quantile loss to directly model the quantile level.

The Quantile regressor 2082 may perform auto-regression to estimate different quantiles of the residual distribution for Non-Gaussian noise to generate accurate prediction 210 for the moderate sparse time series datasets 202.

Referring to in FIG. 2A-2C, for the extremely sparse time series datasets 204, the explainable Quantile Hurdle modeling system 125 may include a Hurdle classifier 206, a Hurdle regressor 208 and a probability filter 212 to generate time series prediction 214.

The time series prediction model 2081 may predict a prediction value \hat{x}ₜ at a time step is (e.g., weekly, or monthly, etc.) based on a subset of extremely sparse time series datasets 204 or a subset of previous data points with actual values (xₜ₋ₙ, xₜ₋₁) before the time step is corresponding to previous events. The time series prediction model 2081 may further generate a prediction interval and residual (xₜ-\hat{x}ₜ) at the time step tₛ based on the subset of time series datasets or data points. Quantile regressor 2082 may perform Quantile-based confidence bound computation based on the residuals (xₜ-\hat{x}ₜ) generated by the time series prediction model and a set of parameters cᵢ to estimate the confidence bound to generate prediction intervals. The set of model parameters cᵢ may be tuned to the extremely sparse time series datasets with different values for trend and/or seasonality components as opposed to the set of model parameters bᵢ for the moderate sparse time series.

Hurdle regressor 208 may be implemented by respective algorithms of various machine learning models suitable for extremely sparse time series datasets 204.

Hurdle classifier 206 may predict whether an event relating to the time series is likely to occur by generating a probability of the event at a time step granularity (e.g., daily, weekly, etc.). For the extremely sparse time series datasets 204, Hurdle classifier 206 may be trained to predict the probability of the event for each data point the time step is daily. For example, Hurdle classifier 206 may generate a set of probabilities (p1, p2 . . . p7) for a sub-period of time series datasets within a week.

For a sub-period of time series datasets, the system 200 may use a probability filter 212 to determine a period probability p(w) of events occurred in a week based on an equation (2):

p(w)=1-(1-p1)*(1-p2)* . . . *(1-p7) (2)

The probability filter 212 may function as a binary filter by comparing the period probability p(w) to a probability threshold. The output of Hurdle Regressor 208 may be determined to be the prediction value for the set of corresponding datasets within in the week when the probability p(w) is above the probability threshold. Details about processes related to system 200 will be described below.

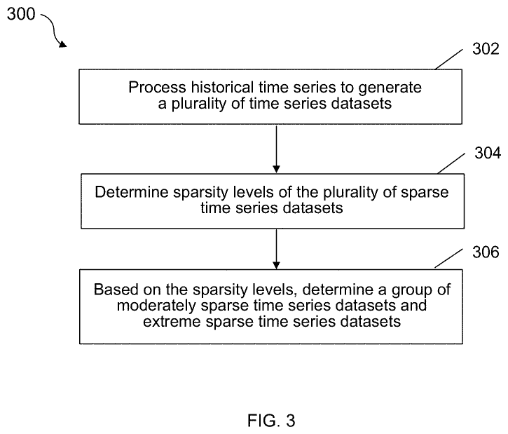

FIG. 3 illustrates an example process that may be executed to generate time series datasets for training models and modeling system of the system 200 to generate time series prediction in accordance with some embodiments of the present disclosure.

At 302, the processor 121 may receive historical time series datasets 127 from the database 126. For example, each time series dataset may represent time series digital values or numbers corresponding to a set of features associated with related events. Each time series dataset may be graphically presented as a set of data points indicative values at respective time steps over a time window or a time frame given the time series. The time series datasets may have varying sparsity levels. The sparsity level may be related to percentage of nonzero values, periodicity metrics, number of peaks, and length of time series.

At 304, the processor 121 may identify and determine a sparsity level of each time series dataset for determining whether each time series dataset is a sparse time series. The processor 121 may process each time series dataset to determine whether a time series data has the sparsity level beyond or below a sparsity threshold. For example, the sparsity levels for the time series datasets may be determined by calculating a percentage or a ratio of nonzero values of the time series dataset as each respective sparsity level of each time series dataset over a time period.

At 306, based on the sparsity levels of the time series datasets, the processor 121 may determine and group the time series datasets as two groups including moderately sparse time series datasets (e.g., a first set of time series datasets) and extremely sparse time series datasets (e.g., a second set of time series datasets). If the sparsity levels of time series datasets are determined lower than the sparsity threshold, the sparse time series datasets may be grouped as extremely sparse time series datasets. If the sparsity levels of time series datasets are determined above or equal to the sparsity threshold, the sparse time series datasets may be grouped as moderate sparse time series datasets. In some embodiments, the sparsity thresholds may vary across different ranges for time series data. The sparsity thresholds may depend on qualities of the time series, such as periodicity, non-stationarity, etc. In one or more embodiments, a time series dataset may be categorized or grouped as the extremely sparse time series dataset if a ratio of the number of data points to the length of the time series is less or equal to 0.1. A time series dataset may be categorized or grouped as the moderate sparsity time series dataset if the ratio of the number of data points to the length of the time series is more than 0.1 and less than or equal to 0.5. A time series dataset may be grouped as a non-sparse time series if the ratio of the number of data points to the length of the time series is more than 0.5. These values are presented as examples that can be used in some embodiments, although it may be possible to use different values to categorize sparsity in other embodiments.

For the moderately sparse time series datasets, the time series forecasting models 2081 may be able to predict the mean/median values accurately. However, the prediction may result in uncertainty with wide and inflated confidence bounds which may lead to uncertainty estimates of the prediction intervals and may not provide very useful prediction information for sparse time series data. The quantile regressor may be trained based on the residuals from the time series prediction models with a set of parameters bᵢ to generate an accurate quantile-based confidence bound.

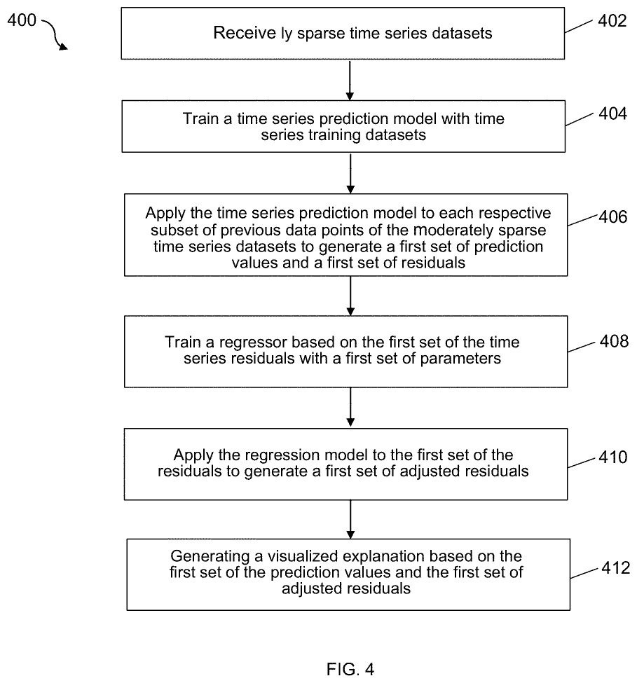

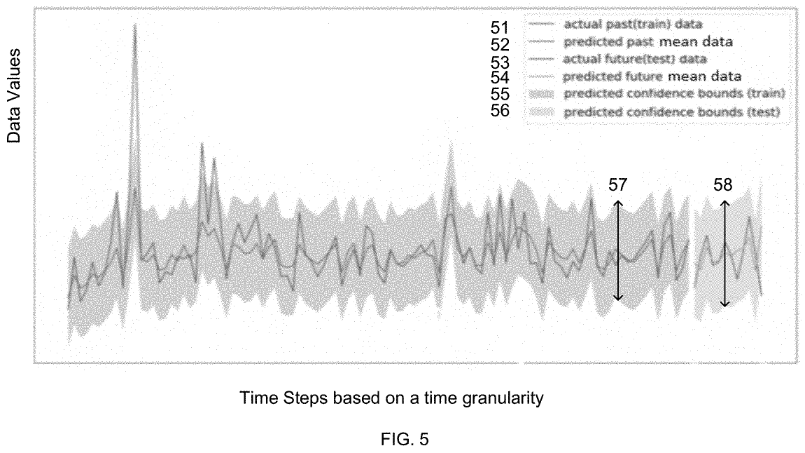

FIG. 4 is a flowchart illustrating an example method and process 400 of generating time series prediction with a Hurdle Regressor for moderately sparse time series datasets in accordance with some embodiments disclosed herein. FIG. 5 show example plots generated based on outputs of the time series prediction model 2081 for processing moderately sparse time series datasets or a first set of datasets 202.

At 402, server computer 120 may receive a first set of time series datasets 202 from database 126. The processor 121 may perform operations to generate different groups of time series datasets including actual past training datasets 51 and actual future test datasets 53. The first set of time series datasets 202 may each correspond to a data point indicative of a data value. Each data point or dataset may correspond to each respective subset of previous data points at a first time granularity within a time window. For example, a first time granularity may be a daily or weekly granularity. Referring to FIG. 2C, a time window may be multiple granularity time periods corresponding to each subset of previous datasets at time steps (t-1, . . . , t-n) before a time step t where the data value \hat{x}ₜ may be predicted.

At 404, the processor 121 may train a time series prediction model 2081 with actual past training datasets 51 and actual future test datasets 53. In some embodiments, a Bayesian linear model be trained with a set of coefficients aᵢ to estimate the prediction values or mean/median values \hat{x}ₜ for the respective time series datasets.

At 406, the time series prediction model 2081 may be executed by the processor 121 to apply to each respective subset of previous data points to generate a first set of predicted mean/median values (e.g., predicted past mean data 52) and a first set of time series residuals. The trained time series prediction model 2081 may generate accurate mean values as predicted past mean data or datasets 52. As illustrated in FIG. 5, the time series prediction model 2081 may also generate predicted confidence bounds (training) 55 with a blue shared area, prediction intervals 57 and corresponding time series residuals (xₜ-\hat{x}ₜ) for each data point of the actual past (training) dataset 51. For each data point of the actual future (test) dataset 53, the time series prediction model 2081 may generate predicted mean values 54 (shown as predicted future mean data in FIG. 5), predicted confidence bounds (test) 56, prediction intervals 58 and corresponding time series residuals.

A prediction interval 57 may represent a range of likely prediction values of an output variable from the time series prediction model 2081. A prediction interval 57 may be a range of values between a maximum upper confidence bound and a minimum lower confidence bound for each corresponding time serials dataset or data point. The existing models normally assume that the time series residuals are subject to Gaussian noise signal. As illustrated in FIG. 5, the time series prediction model may generate the prediction 212 resulting in very wide prediction intervals 57 with a blue shaded area on both sides of the data points of the predicted mean values 52. The wide prediction interval 57 may represent uncertainty about the prediction values of time series data-points with uncertainty bounds since the corresponding residuals may not have a normal distribution or Gaussian distribution.

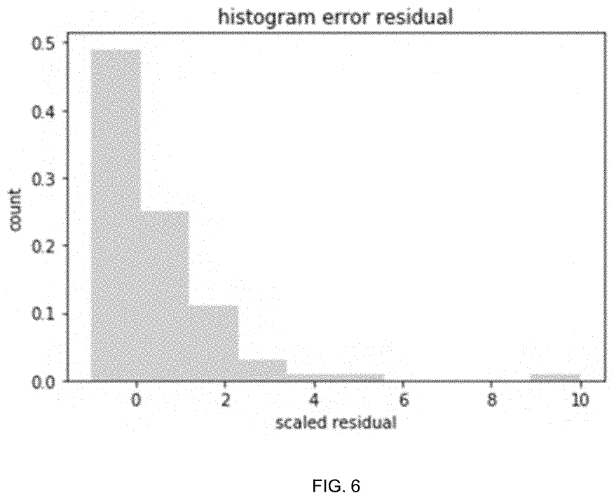

FIG. 6 shows scaled residuals corresponding to the prediction intervals 57 for moderately sparse time series datasets 202. The scaled residuals are characterized as a non-normally distributed distribution and not a Gaussian distribution. The time series prediction models may be a Structural Bayesian Time Series (SBTS) model and many other state-of-the-art models. The existing time series prediction models may assume a Gaussian noise distribution of the residuals, which leads to inaccurate uncertainty estimates of the prediction intervals.

At 408, the processor 121 may train a quantile regressor 2082 to perform quantile-based confidence bound computation based on the time series residuals generated by the time series prediction model 2081 along with a first set of model parameters bᵢ to predict the confidence bounds for improving the prediction interval estimation.

At 410, the processor 121 may apply the quantile regressor 2082 to the first set of residuals generated by the time series prediction model 2081 to generate a first set of adjusted residuals. The quantile regressor 2082 may perform quantile-based confidence bound computation based on the prediction residuals (xₜ-\hat{x}ₜ) from the time series prediction model for actual past (training) data and actual future (test) data from the moderately sparse time series datasets 202. Quantile regressor 2802 may make no assumptions about the distribution of the prediction residuals from the time series prediction model 2081. Referring to FIG. 2A, Quantile regressor 2082 may generate the prediction 212 with the first set of prediction values, a first set of adjusted residuals and a first set of accurate adjusted prediction intervals as an output of the prediction 210 based on accurate predicted mean values from the time series prediction model 2081.

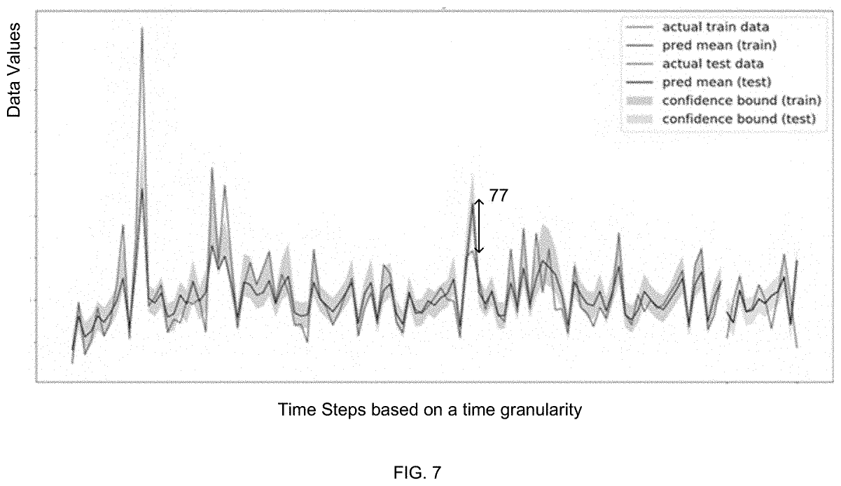

FIG. 7 shows example plots based on outputs of the quantile regressor 2082 for processing moderately sparse time series datasets related to process 400 in accordance with some embodiments disclosed herein. As shown in FIG. 7, quantile regressor 2082 may generate the prediction 210 with predicted mean values shown as blue for the time series prediction model 2081 and accurate adjusted prediction intervals 77 with tight confidence bounds with blue shaded area. For example, the prediction interval 77 is located only on one side of the predicted mean value at time step tₛ, which reflects the time series with Non-Gaussian noise feature and a prediction accuracy of prediction intervals.

At 412, the processor 121 may generate a visualized explanation to present the generated prediction 210 including and or based on prediction values and prediction intervals for respective data points of the first time series datasets 202.

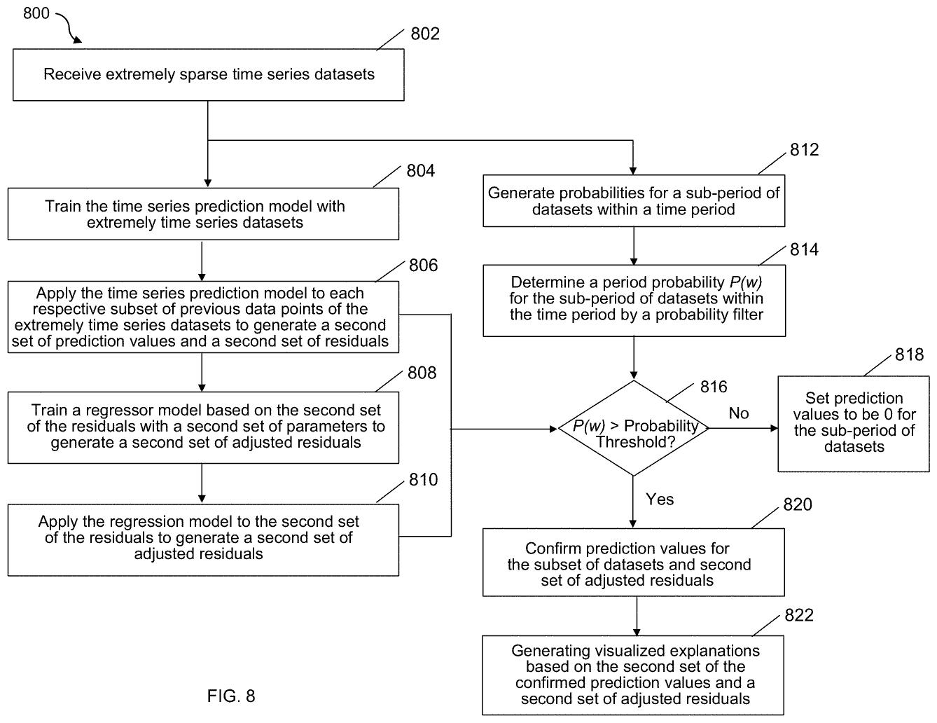

FIG. 8 is a flowchart illustrating an example process 800 for processing extremely sparse time series datasets to build an explainable Quantile Hurdle modeling system 125 to forecast extremely sparse time series in the future in accordance with some embodiments disclosed herein.

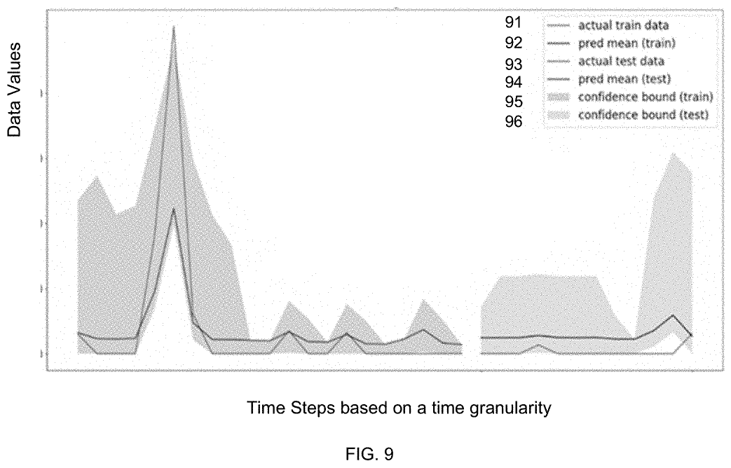

FIG. 9 shows example plots generated based on outputs of the time series prediction model for processing extremely sparse time series datasets in accordance with some embodiments disclosed herein.

At 802, server computer 120 may receive extremely sparse time series datasets or a second set of time series datasets 204 from database 126. The processor 121 may perform operations to generate different groups of time series datasets including actual past training datasets 91 and actual future test datasets 93 as shown in FIG. 9.

At 804, the processor 121 may train a time series prediction model 2081 with actual training datasets 91 and actual test datasets 93.

At 806, the trained time series prediction model 2081 may be executed by the processor 121 to apply to each respective subset of previous data points of the extremely sparse time series datasets to generate a second set of predicted mean/median values (e.g., predicted mean of (training) data 92), a second set of prediction values, a second set of prediction intervals, and a second set of time series residuals. As illustrated in FIG. 9, the time series prediction model 2081 may also generate predicted confidence bounds (training) 95 with a blue shared area and prediction intervals for respective datasets. For each data point of the actual test datasets 93, the time series prediction model 2081 may generate predicted mean values 94 (e.g., predicted mean (test) data in FIG. 9), predicted confidence bounds (test) 96, a wide upper confidence bound shown in blue area, the second set of prediction intervals corresponding to the second set of time series residuals.

At 808, the processor 121 may train a quantile regressor 2082 to perform quantile-based confidence bound computation based on a second set of the time series residuals generated by the time series prediction model 2081 along with a second set of model parameters cᵢ to predict the confidence bounds for improving the prediction interval estimation.

At 810, the processor 121 may apply the quantile regressor 2082 to the second set of residuals generated by the time series prediction model 2081 to generate a second set of prediction values and a second set of adjusted residuals. The Quantile regressor 2082 may perform quantile-based confidence bound computation based on the residuals (xₜ-\hat{x}ₜ) from the time series prediction model for actual training datasets 91 and actual test datasets 93 from the extremely sparse time series datasets 204. Referring to FIG. 2A, the Quantile regressor 2082 may generate the prediction with a second set of the prediction values and a second set of accurate adjusted prediction intervals as an output of the outputs of Hurdle Regressor 208 based on accurate predicted mean values.

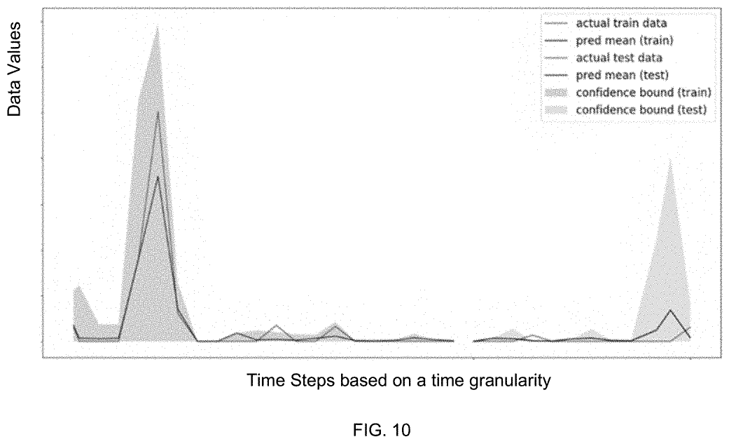

FIG. 10 show example plots generated based on outputs of quantile regressor 2082 for processing extremely sparse time series datasets 204 or a second set of datasets 202. As shown in FIG. 10, quantile regressor 2082 may generate the prediction 214 with predicted mean values shown as blue for the time series prediction model 2081 and accurate prediction intervals with tight confidence bounds with blue shaded area. FIG. 10 shows how the quantile hurdle model 2082 can improve the estimation of prediction intervals for extremely sparse time series in comparison to the wide prediction intervals from the time series prediction 2081 in FIG. 9.

At 812, referring to FIG. 2A, Hurdle classifier 206 may be executed by the processor 121 to predict whether an event relating to the time series is likely to occur. Hurdle classifier 206 may be trained by the extreme sparse time series datasets or the second set of time series datasets 204 to predict a probability of the event at a first time granularity (e.g., daily). For example, based on the extremely sparse time series datasets 204, Hurdle classifier 206 may be trained to predict the probability of the event for each data point at the time step is daily or a first time granularity. Hurdle classifier 206 may generate a set of probabilities (p1, p2 . . . p7) for a sub-period of time series datasets within a time period, such as a week or a time period of a second time granularity.

At 814, for the sub-period of time series datasets, the processor 121 may determine a period probability p(w) of events occurred in the time period based on equation (2) described above.

At 816, the processor 121 may execute an algorithm of a probability filter 212 to compare the period probability p(w) to a probability threshold. The probability threshold may be unique to respective time series datasets. The threshold value may be different for each time series and adjusted based on historic time series data.

At 818, when the processor 121 determines that the period probability p(w) is equal or below the probability threshold, the processor may set the prediction values or the output of Hurdle Regressor 208 to be 0 as the prediction result 214 for the corresponding sub-period of time series datasets within the time period.

At 820, when the processor 121 determines that the period probability p(w) is above the probability threshold, the processor may confirm the second set of the prediction values and the second set of the adjusted prediction intervals from quantile regressor 2082 for the sub-period of datasets within the time period. The prediction result 214 may include the second set of the prediction values and the second set of the adjusted prediction intervals on a weekly granularity. The prediction result 214 may be aggregated to a suitable prediction granularity, such as a monthly granularity.

At 822, the processor 121 may generate a visualized explanation to present the generated prediction 214 including or based on the second set of the prediction values and a second set of the adjusted prediction intervals for respective data points of the second time series datasets 204.

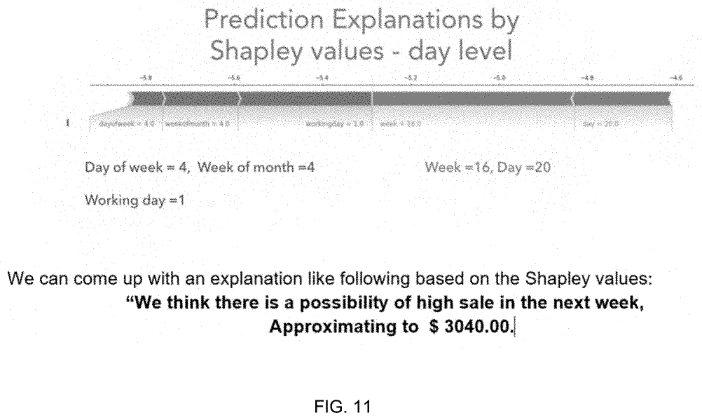

FIG. 11 shows an example user interface presenting the prediction explanations of the forecast result in accordance with some embodiments disclosed herein. A prediction explanation may be generated using Shapley values for presenting prediction results associated with events in the future such that related users may understand the forecasted results of their historical activities and events. The prediction explanation may include a plurality of temporal features associated with events and time series of the events, and text explanation based on the generated prediction 210 or 214 including corresponding prediction values and prediction intervals.

Referring to FIG. 2A, without considering the sparsity level, the process 400 may be used to apply Hurdle Regressor 208 to a set of sparse time series dataset to generate prediction 210. The process 800 may be used to apply Hurdle classifier 206 and Hurdle Regressor 208 to generate prediction 214. The processor 121 may compare the prediction accuracy of the prediction 210 and prediction 214 to determine whether to choose process 400 or process 800 as a suitable process to generate a final prediction.

In some embodiments, different time series prediction models or algorithms may be selected for quantile hurdle modeling systems to perform sparse time series data prediction based on the model performance evaluation. A metric called Normalized Mean Absolute Error (NMAE) may be used to evaluate the improvement and compare the models or quantile hurdle modeling system performance among the different models and algorithms.

$$NMAE = \frac{Mean Absolute Error from a model ( MAE )}{MAE of the trivial predictor}$$

The MAE of trivial predictor refers to predictions determined using mean of historic data. This metric compares the performance of the algorithm to the mean prediction of the historic data. A model or quantile hurdle modeling system may quantify a better performance with the lower NMAE value. If the NMAE value is larger than 1, the model may generate prediction with a lower accuracy performance compared with the mean of historic data.

In some embodiments, the disclosed principles provide a practical technological solution to effectively and accurately generate predicted time series data. Embodiments of the present disclosure provide advantages and improvements of processing moderately and extremely sparse time series datasets for predicting future values embedding. For example, the embodiments described herein provide computational efficiency and predictive accuracy with related machine learning tasks. The advantages of the disclosed principles include providing accuracy in extremely sparse time series prediction. The disclosed methods may assist users to process historical time series to predict corresponding events that may occur in the future. The generated prediction explanations may provide better service and or personalized service tailored to associated users or entities.

The embodiments described herein may provide a real time solution with faster processing and delivery of event predication that satisfy user expectations and improve user experience when the users interact with the system for managing event-related time series activities and obtaining related information and advice to manage their registered accounts with the online services.

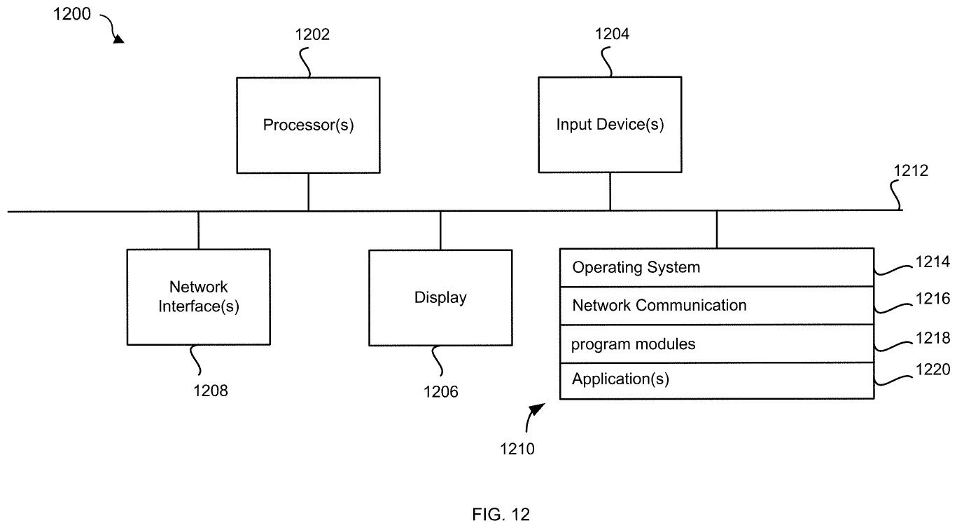

FIG. 12 is a block diagram of an example computing device 1200 that may be utilized to execute embodiments to implement processes including various features and functional operations as described herein. For example, computing device 1200 may function as server computer 120, and user computing device 130 or a portion or combination thereof. In some implementations, the computing device 1200 may include one or more processors 1202, one or more input devices 1204, one or more display devices or output devices 1206, one or more communication interfaces 1208, and memory 1210. Each of these components may be coupled by bus 1212, or in the case of distributed computer systems, one or more of these components may be located remotely and accessed via a network. The computing device 1200 may be implemented on any electronic device to execute software applications derived from program instructions stored in the memory 1210, and includes but not limited to personal computers, servers, smartphones, media players, electronic tablets, game consoles, email devices, etc.

Processor(s) 1202 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-transitory memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

Input devices 1204 may be any known input devices technology, including but not limited to a keyboard (including a virtual keyboard), mouse, track ball, and touch-sensitive pad or display. To provide for interaction with a user, the features and functional operations described in the disclosed embodiments may be implemented on a computer having a display device 1206 such as a CRT (cathode ray tube) or LCD (liquid crystal display) monitor for displaying information to the user and a keyboard and a pointing device such as a mouse or a trackball by which the user can provide input to the computer. Display device 1206 may be any known display technology, including but not limited to display devices using Liquid Crystal Display (LCD) or Light Emitting Diode (LED) technology.

Communication interfaces 1208 may be configured to enable computing device 1200 to communicate with other another computing or network device across a network, such as via a wired connection, a wireless connection, or a combination of wired and wireless connections. For example, communication interfaces 1208 may include an Ethernet interface, an optical interface, a coaxial interface, an infrared interface, a radio frequency (RF) interface, a universal serial bus (USB) interface, a Wi-Fi interface, a cellular network interface, or the like.

Memory 1210 may be any computer-readable medium that participates in providing computer program instructions and data to processor(s) 1202 for execution, including without limitation, non-transitory computer-readable storage media (e.g., optical disks, magnetic disks, flash drives, etc.), or volatile media (e.g., SCRAM, ROM, etc.). Memory 1210 may include various instructions for implementing an operating system 1214 (e.g., Mac OS®, Windows®, Linux). The operating system may be multi-user, multiprocessing, multitasking, multithreading, real-time, and the like. The operating system may perform basic tasks, including but not limited to: recognizing inputs from input devices 1204; sending output to display device 1206; keeping track of files and directories on memory 1210; controlling peripheral devices (e.g., disk drives, printers, etc.) which can be controlled directly or through an I/O controller; and managing traffic on bus 1212. Bus 1212 may be any known internal or external bus technology, including but not limited to ISA, EISA, PCI, PCI Express, USB, Serial ATA or FireWire.

Network communications instructions 1216 may establish and maintain network connections (e.g., software applications for implementing communication protocols, such as TCP/IP, HTTP, Ethernet, telephony, etc.). Application(s) 1220 and program modules 1218 may include software application(s) and different functional program modules which are executed by processor(s) 1202 to implement the processes described herein and/or other processes. The program modules 1218 may include but are not limited to software programs, machine learning models, objects, components, data structures that are configured to perform tasks or implement the processes described herein. The processes described herein may also be implemented in operating system 1214.

The features and functional operations described in the disclosed embodiments may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

The described features and functional operations described in the disclosed embodiments may be implemented in a computer system that includes a back-end component, such as a data server, or that includes a middleware component, such as an server computer or an Internet server, or that includes a front-end component, such as a user device having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include user computing devices and server computers. A user computing device and server may generally be remote from each other and may typically interact through a network. The relationship of user computing devices and server computer may arise by virtue of computer programs running on the respective computers and having a client-server relationship to each other.

Communication between various network and computing devices 1200 of a computing system may be facilitated by one or more application programming interfaces (APIs). APIs of system may be proprietary and/or may be examples available to those of ordinary skill in the art such as Amazon® Web Services (AWS) APIs or the like. The API may be implemented as one or more calls in program code that send or receive one or more parameters through a parameter list or other structure based on a call convention defined in an API specification document. One or more features and functional operations described in the disclosed embodiments may be implemented using an API. An API may define one or more parameters that are passed between an application and other software instructions/code (e.g., an operating system, library routine, function) that provides a service, that provides data, or that performs an operation or a computation. A parameter may be a constant, a key, a data structure, an object, an object class, a variable, a data type, a pointer, an array, a list, or another call.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method implemented by a computing device for generating time series prediction, the computing device comprising a processor and a memory, the memory storing executable instructions that when executed by the processor cause the computing device to perform processing comprising:
receiving, from a database in communication with the processor, a plurality of time series datasets each corresponding to a data point indicative of a data value, each data point corresponding to each respective subset of previous data points at a first time granularity within a time window;
generating a first set of sparse datasets having sparsity levels equal to or below a sparsity threshold and a second set of sparse datasets having sparsity levels above the sparsity threshold;
applying a time series forecasting model to each respective subset of previous data points of the first set of sparse datasets increasingly at the first time granularity to generate a first set of prediction values and a first set of residuals;
applying a regression model to the first set of the prediction residuals to generate a first set of adjusted residuals for the first set of sparse datasets; and
generate a visualized explanation based on the first set of the prediction values and the first set of adjusted residuals for one or more of the first set of sparse datasets.

2. The method of claim 1, wherein the processing further comprises calculating a percentage of nonzero values of the time series dataset as each respective sparsity level of each respective time series dataset.

3. The method of claim 1, wherein the processing further comprises:
applying a time series forecasting model to each respective subset of previous data points of the second set of sparse datasets increasingly at the first time granularity to generate a second set of prediction values and a second set of residuals; and
applying a regression model to the second set of the residuals to generate a second set of adjusted residuals for the second set of sparse datasets.

4. The method of claim 3, wherein the processing further comprises:
applying an ensemble classifier to the second set of the sparse datasets to predict a set of probabilities for a sub-period of the second sparse datasets at the first time granularity with a period of a second time granularity, the second time granularity being multiple time steps of the first time granularity, the period of the second time granularity being one of a weekly time granularity or a monthly time granularity;
applying a probability filter to the set of probabilities to determine a period probability corresponding to the sub-period of the second sparse datasets with the period of the second time granularity;
determining whether the period probability is equal or below a probability threshold;
responsive to determining the period probability being above a probability threshold, confirming the prediction values and the second set of the adjusted residuals for the sub-period of datasets within the time period; and
generating a visualized explanation based on the second set of the prediction values and a second set of adjusted residuals for one or more of the first set of sparse datasets.

5. The method of claim 4, wherein the processing further comprises: responsive to determining the period probability being equal to or below a probability threshold, setting zero as the prediction values for respective sub-period of datasets within the time period.

6. The method of claim 1, wherein each residual is indicative of a difference between each respective data value and respective prediction value corresponding to each respective data point.

7. The method of claim 1, wherein the visualized explanation comprises a respective prediction value embedded with texts and graphs presented in one or more temporal features.

8. The method of claim 1, wherein the time series forecasting model is trained with respective time series datasets corresponding to respective sparsity levels of the time series datasets.

9. The method of claim 1, wherein the regression model is a quantile regression model is trained with a set of respective parameters of respective sparsity levels of the time series datasets.

10. The method of claim 9, wherein a set of respective parameters comprise a data value, a set of quantile values, and a plurality of temporal features comprising a date, day, week, month, day of the week, and week of the month.

11. A computing system, comprising:
a server computing device comprising a processor and a memory;
a database in communication with the processor and configured to store a plurality of time series datasets, and
a machine learning system comprising a time series forecasting model, a regression model and an ensemble classifier, the machine learning system including computer-executable instructions stored in a memory and executed by the processor to cause the server computing device to perform processing comprising:
receiving, from a database in communication with the processor, a plurality of time series datasets each corresponding to a data point indicative of a data value, each data point corresponding to each respective subset of previous data points at a first time granularity within a time window;
generating a first set of sparse datasets having sparsity levels equals to or below a sparsity threshold and a second set of sparse datasets having sparsity levels above the sparsity threshold;
applying a time series forecasting model to each respective subset of previous data points of the first set of sparse datasets increasingly at the first time granularity to generate a first set of prediction values and a first set of residuals;
applying a regression model to the first set of the prediction residuals to generate a first set of adjusted residuals for the first set of sparse datasets; and
generating a visualized explanation based on the first set of the prediction values and the first set of adjusted residuals for one or more of the first set of sparse datasets.

12. The system of claim 11, wherein the processing further comprises calculating a percentage of nonzero values of the time series dataset as each respective sparsity level of each respective time series dataset.

13. The system of claim 11, wherein the processing further comprises:
applying a time series forecasting model to each respective subset of previous data points of the second set of sparse datasets increasingly at the first time granularity to generate a second set of prediction values and a second set of residuals; and
applying a regression model to the second set of the residuals to generate a second set of adjusted residuals for the second set of sparse datasets.

14. The system of claim 13, wherein the processing further comprises:
applying an ensemble classifier to the second set of the sparse datasets to predict a set of probabilities for a sub-period of the second sparse datasets at the first time granularity with a period of a second time granularity, the second time granularity being multiple time steps of the first time granularity, the period of the second time granularity being one of a weekly time granularity or a monthly time granularity;
applying a probability filter to the set of probabilities to determine a period probability corresponding to the sub-period of the second sparse datasets with the period of the second time granularity;
determining whether the period probability is equal or below a probability threshold;
responsive to determining the period probability being above a probability threshold, confirming the prediction values and the second set of the adjusted residuals for the sub-period of datasets within the time period; and
generating a visualized explanation based on the second set of the prediction values and a second set of adjusted residuals for one or more of the first set of sparse datasets.

15. The system of claim 14, wherein the processing further comprises: responsive to determining the period probability being equal to or below a probability threshold, setting zero as the prediction values for respective sub-period of datasets within the time period.

16. The system of claim 11, wherein each residual is indicative of a difference between each respective data value and respective prediction value corresponding to each respective data point.

17. The system of claim 11, wherein the visualized explanation comprises a respective prediction value embedded with texts and graphs presented in one or more temporal features.

18. The system of claim 11, wherein the time series forecasting model is trained with respective time series datasets corresponding to respective sparsity levels of the time series datasets.

19. The system of claim 11, wherein the regression model is a quantile regression model which is trained with a set of respective parameters of respective sparsity levels of the time series datasets.

20. The system of claim 19, wherein a set of respective parameters comprise a data value, a set of quantile values, and a plurality of temporal features comprising a date, day, week, month, day of the week, and week of the month.
